(19) United States
(12) Patent Application Publication
(10) Pub. No.: US 2026/0045668 A1
(43) Pub. Date: Feb. 12, 2026

(54) BATTERY ASSEMBLY

(71) Applicant: HYUNDAI MOBIS CO., LTD., Seoul (KR)

(72) Inventor: Yoo Jeong LEE, Yongin-si (KR)

(73) Assignee: HYUNDAI MOBIS CO., LTD., Seoul (KR)

(21) Appl. No.: 19/235,970

(22) Filed: Jun. 12, 2025

(30) Foreign Application Priority Data
Aug. 12, 2024 (KR) 10-2024-0107765

(51) Int. Cl. H01M 50/595; H01M 50/103

(52) U.S. Cl. CPC H01M 50/595; H01M 50/103

(57) ABSTRACT

A battery assembly includes a plurality of battery cells each including electrodes and separators, a casing part defining an internal space configured to accommodate the plurality of battery cells, and a fracturable part attached to one side of the casing part. The casing part includes a casing hole formed at one side thereof, and the fracturable part includes a tape member disposed to cover at least a portion of the casing hole and bonded to the casing part or to another structural component of the fracturable part.

### CROSS-REFERENCE TO RELATED APPLICATION

This application claims the benefit under 35 U.S.C. § 119(a) of Korean Patent Application No. 10-2024-0107765 filed on Aug. 12, 2024 in the Korean Intellectual Property Office, the entire disclosure of which is incorporated herein by reference for all purposes.

### BACKGROUND ART

### 1. Field

The present disclosure relates to a battery assembly, and more particularly, to a battery assembly having a structure capable of discharging a gas in the battery assembly.

### 2. Discussion of Related Art

The statements in this section merely provide background information related to the present disclosure and do not necessarily constitute prior art.

An aerial mobility vehicle, such as a drone, which flies through the air, is equipped with a battery module or a battery pack configured to provide driving power. For example, the battery module or the battery pack is mounted in a body, a wing, or the like of the aerial mobility vehicle.

Meanwhile, in case that the battery module or the battery pack is mounted in the aerial mobility vehicle, the battery module or the battery pack is often exposed to downwash applied to the aerial mobility vehicle because of the nature of the aerial mobility vehicle. In this case, the battery module or the battery pack is exposed to pressure and vibration caused by the downwash. In this case, a problem may occur in which a venting device provided in the battery module or the battery pack operates erroneously. In contrast, each country has regulations that require batteries mounted in aerial mobility vehicles to discharge a larger amount of gas in a shorter period of time than ground mobility vehicles.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure has been made in an effort to provide a novel venting device that is provided in a battery module or a battery pack mounted in an aerial mobility vehicle and quickly discharges an internal gas or the like in the event of an emergency without erroneously operating.

In one general aspect, a battery assembly including: a plurality of battery cells each including electrodes and separators; a casing part defining an internal space configured to accommodate the plurality of battery cells; and a fracturable part attached to one side of the casing part. The casing part includes a casing hole formed at one side thereof, and the fracturable part includes a tape member disposed to cover at least a portion of the casing hole and bonded to the casing part or to another structural component of the fracturable part.

The tape member may include a material having an adhesive property that decreases in at least a specific temperature range as the temperature increases.

The fracturable part may further include a base member fixedly coupled to a region of the casing part that defines a boundary of the casing hole, the base member having a base hole configured to be in communication with at least a portion of the casing hole, and the tape member may be configured to cover the base hole and may be bonded to a region of the base member that defines a boundary of the base hole.

A thickness of the base member may be smaller than a thickness of the region of the casing part to which the base member is fixedly coupled.

The fracturable part may further include a penetration member configured to penetrate both the base member and the casing part, and the penetration member may include a plurality of penetration members spaced apart from one another along a peripheral region of the casing hole.

The tape member may include: an adhesive layer attached to the base member; and a protective layer disposed on an outer surface of the adhesive layer.

The adhesive layer may include an acrylic-based adhesive agent or a silicon-based adhesive agent, and the protective layer may include aluminum.

A tape hole may be formed in the adhesive layer and configured to communicate with the casing hole and the base hole, and the protective layer may be configured to cover the tape hole.

Each of the adhesive layer and the tape hole may have a have a rectangular shape.

A width of the adhesive layer, defined as a distance between an outer periphery of the adhesive layer and the tape hole, may be constant.

The tape hole may have a rectangular shape having a first side of length a and a second side of length b. The tape member may be configured to satisfy the following Expressions 1 and 2 under a condition in which an external pressure applied to the casing part is equal to or greater than an internal pressure of the casing part:
Expression 1: F_{ad}×a>Pa²b/{2(a+b)},
Expression 2: F_{ad}×b>Pab²/{2(a+b)}. P represents a difference between the external pressure and the internal pressure of the casing part, and F_{ad} represents a bonding force per unit length of the tape member.

The tape hole may have a rectangular shape having a first side of length a and a second side of length b. The adhesive layer may have a rectangular shape having a first side of length c facing the first side of the tape hole and a second side of length d facing the second side of the tape hole. The tape member may be configured to satisfy the following Expressions 3 and 4 under a condition in which an external pressure applied to the casing part is equal to or greater than an internal pressure of the casing part:
Expression 3: [Pa²b/{2(a+b)}]/σₜ<{(d-b)/2}×(1+ε) ,
Expression 4: [Pab²/{2(a+b)}}/σₜ<{(c-a)/2}×(1+ε), and in which σₜ represents a tensile strength (N/mm) of the tape member, and ε represents extensibility of the tape member.

The tape hole may have a rectangular shape having a first side of length a and a second side of length b, and the tape member may be configured to satisfy the following Expressions 5 and 6 under a condition in which thermal runaway occurs in at least some of the plurality of battery cells,
Expression 5: Pa²b/{2(a+b)}×y>F_{ad}×a,
Expression 6: Pab²/{2(a+b)}×y>F_{ad}×b, and in which P represents a pressure difference between an external pressure and an internal pressure of the casing part, F_{ad} represents a bonding force per unit length of the tape member, and y represents a decrease rate of a bonding force of the adhesive layer in response to an increase in temperature.

In another general aspect, a battery assembly including: a plurality of battery cells each including electrodes and separators; a casing part defining an internal space configured to accommodate the plurality of battery cells, and having a casing hole formed at one side thereof; a base member coupled to a region of the casing part that defines a boundary of the casing hole and having a base hole formed to communicate with at least a partial region of the casing hole; and a tape member configured to cover the base hole and bonded to the base member. The tape member includes a temperature-responsive adhesive layer and a protective layer, and the tape member is configured to peel off from the casing part when an internal pressure of the casing part exceeds a predetermined threshold, thereby releasing internal gas or pressure.

The adhesive layer may be configured such that its bonding strength decreases with increasing temperature, and the adhesive layer may include at least one of an acrylic-based adhesive or a silicone-based adhesive.

The protective layer may include a metal material including aluminum, and the tape member may be configured to maintain structural integrity of the protective layer at room temperature and to fracture at elevated temperatures.

The tape member may have a rectangular hole formed therethrough, and the tape member may be configured to satisfy a pressure-bonding balance relationship such that a pressure difference across the casing hole results in detachment of the tape member based on bonding force per unit length.

According to the present disclosure, it is possible to provide the novel venting device that is provided in the battery module or the battery pack mounted in the aerial mobility vehicle and quickly discharges an internal gas or the like in the event of an emergency without erroneously operating.

Other features and aspects will be apparent from the following detailed description, the drawings, and the claims.

### BRIEF DESCRIPTION OF THE DRAWINGS

FIG. 1 is a perspective view of a battery assembly according to the present disclosure.

FIG. 2 is an enlarged exploded perspective view illustrating a fracturable part of the battery assembly according to the present disclosure.

FIG. 3 is a view illustrating a state in which an adhesive layer of a tape member in FIG. 2 is bonded to a base member.

FIG. 4 is a front view of the tape member provided in the battery assembly according to the present disclosure.

FIG. 5 is a view illustrating a state of the fracturable part provided in the battery assembly in case that internal pressure and external pressure are similar to each other.

FIG. 6 is a view illustrating a state of the fracturable part provided in the battery assembly in case that external pressure is higher than internal pressure.

FIG. 7 is a view illustrating a state of the fracturable part provided in the battery assembly in case that internal pressure is higher than external pressure.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

Hereinafter, a battery assembly of the present disclosure will be described. Meanwhile, the battery assembly according to the present disclosure may be a battery module or a battery pack. The use of the term “may” herein with respect to an example or embodiment, e.g., as to what an example or embodiment may include or implement, means that at least one example or embodiment exists where such a feature is included or implemented, while all examples are not limited thereto.

### Battery Assembly

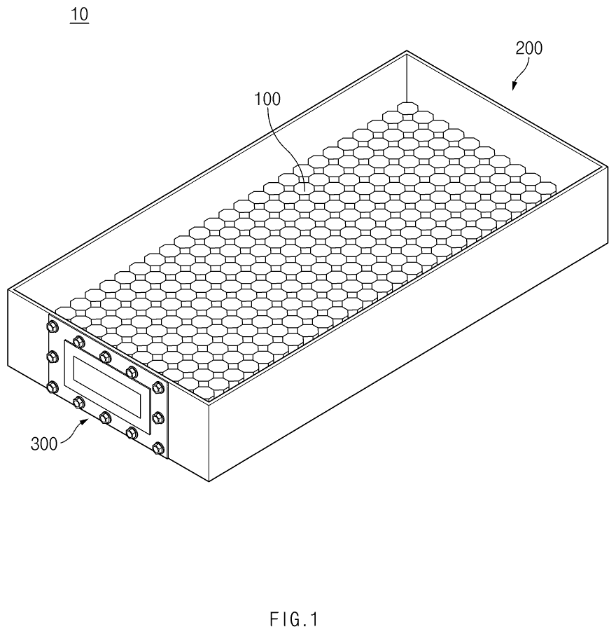

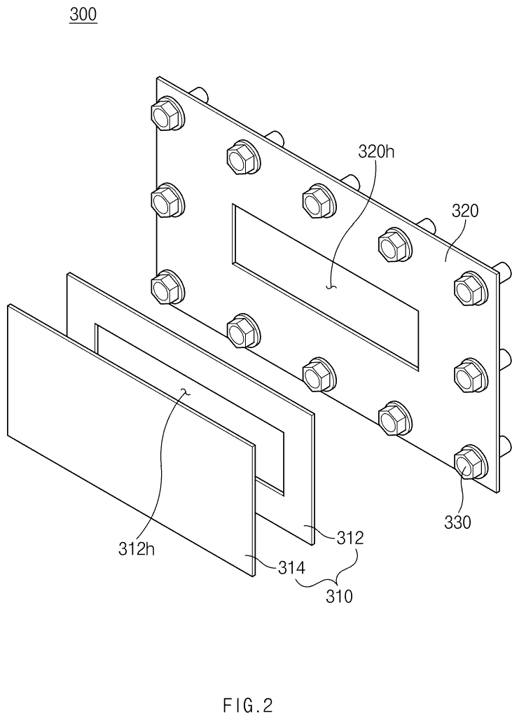

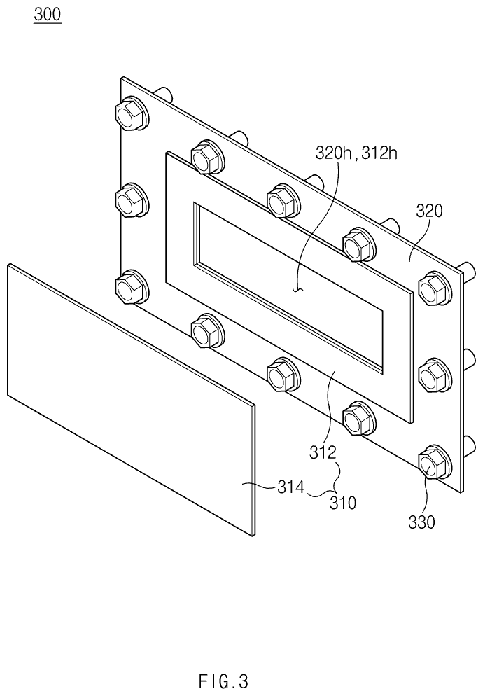

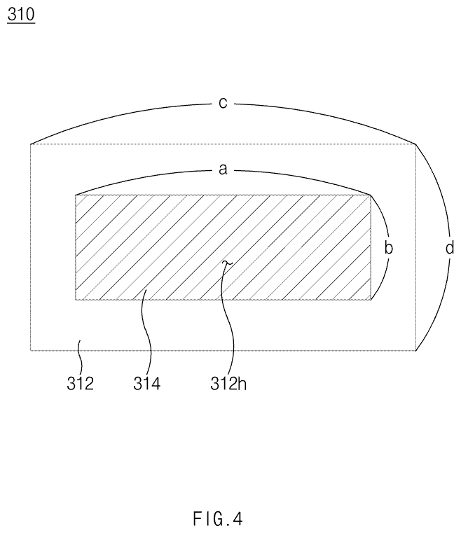

FIG. 1 is a perspective view of a battery assembly according to the present disclosure, and FIG. 2 is an enlarged exploded perspective view illustrating a fracturable part of the battery assembly according to the present disclosure. FIG. 3 is a view illustrating a state in which an adhesive layer of a tape member in FIG. 2 is bonded to a base member, and FIG. 4 is a front view of the tape member provided in the battery assembly according to the present disclosure.

A battery assembly 10 according to the present disclosure may include a plurality of battery cells 100 including electrodes and separators, and a casing part 200 having an internal space configured to accommodate the plurality of battery cells 100. For example, the plurality of battery cells 100 may be structured to be stacked in one direction in the internal space of the casing part 200.

In addition, the battery assembly 10 according to the present disclosure may further include a fracturable part 300 coupled to one side of the casing part 200. The fracturable part 300 protects the internal space of the casing part 200 from the outside at ordinary times. When internal pressure of the casing part 200 exceeds a predetermined range, the fracturable part 300 may be fractured to define a route through which contents containing gases (hereinafter, referred to as ‘gas and the like’) in the casing part 200 are discharged to the outside.

With continued reference to the drawings, a casing hole 200h may be formed at one side of the casing part 200. The casing hole 200h is blocked by the fracturable part 300 at ordinary times. When internal pressure of the casing part 200 exceeds the predetermined range, the fracturable part 300 may be fractured, and the casing hole 200h may define a route through which the gas and the like are discharged to the outside.

More specifically, the fracturable part 300 may include a tape member 310 configured to cover at least a partial region of the casing hole 200h and bonded to the casing part 200 or another component of the fracturable part 300. More particularly, the tape member 310 may be configured to cover the entire region of the casing hole 200h, and a part of the tape member 310 may be bonded to the casing part 200. More specifically, a part of the tape member 310 may be bonded to a region of the casing part 200 that defines a boundary of the casing hole 200h. According to the present disclosure, the casing hole 200h is blocked by the tape member 310 at ordinary times. In case that internal pressure of the casing part 200 exceeds the predetermined range, the tape member 310 and the casing part 200 are released from each other, such that the route through which the gas and the like are discharged to the outside may be defined.

Meanwhile, in general, during an operating process of the battery assembly 10, the internal pressure of the casing part 200 may increase in the event of thermal runaway in the battery cell 100. Therefore, in order to smoothly discharge the gas and the like in the casing part 200 to the outside in the event of thermal runaway in the battery cell 100, the tape member 310 and the casing part 200 need to be quickly released from each other.

In order to achieve the above-mentioned object, the tape member 310 may include or be made of a material having adhesiveness that decreases as a temperature increases in at least a partial temperature section. More particularly, the tape member 310 may include or be made of a material having adhesiveness that decreases in a temperature range in the casing part 200 in the event of thermal runaway in the battery cell 100.

With continued reference to the drawings, the fracturable part 300 of the battery assembly 10 according to the present disclosure may further include a base member 320 fixedly coupled to a region of the casing part 200 that defines a boundary of the casing hole 200h, the base member 320 having a base hole 320h configured to communicate with a partial region of the casing hole 200h. In this case, according to the present disclosure, the tape member 310 may be attached to a region of the base member 320 that defines a boundary of the base hole 320h, and the tape member 310 may be provided to cover the entire region of the base hole 320h.

Meanwhile, as described above, the internal pressure of the casing part 200 may increase in the event of thermal runaway in the battery cell 100. Therefore, in case that the internal pressure of the casing part 200 exceeds the predetermined range, thermal energy in the casing part 200 needs to be quickly transferred to the tape member 310 so that a bonding force of the tape member 310 quickly decreases. In order to achieve the above-mentioned object, according to the present disclosure, a thickness of the base member 320 may be smaller than a thickness of the region of the casing part 200 to which the base member 320 is fixedly coupled. More particularly, the thickness of the base member 320 may be smaller than an overall thickness of the casing part 200. For example, the thickness of the base member 320 may be 3 mm or less, and the thickness of the casing part 200 may be 3 mm or more.

With continued reference to the drawings, the fracturable part 300 may further include penetration members 330 configured to penetrate the base member 320 and the casing part 200. For example, the penetration member 330 may be a bolt member. The penetration members 330 may be provided as a plurality of penetration members 330 spaced apart from one another along a peripheral region of the casing hole 200h.

Meanwhile, according to the present disclosure, the tape member 310 may include an adhesive layer 312 attached to the base member 320, and a protective layer 314 stacked on and attached to an outer surface of the adhesive layer 312. For example, the adhesive layer 312 may include or be made of an acrylic-based adhesive agent or a silicon-based adhesive agent. The acrylic-based adhesive agent may maintain the adhesiveness at a temperature from about −40° C. to about 120° C., and the silicon-based adhesive agent may maintain the adhesiveness at a temperature from about −70° C. to about 260° C. The adhesive layer 312 may include or be made of the acrylic-based adhesive agent so that the adhesiveness of the adhesive layer 312 may be eliminated under a thermal runaway condition in the battery cell. Meanwhile, the protective layer 314 may include or be made of aluminum.

Meanwhile, according to the present disclosure, as illustrated in the drawings, a tape hole 312h may be formed in the adhesive layer 312 and communicate with the casing hole 200h and the base hole 320h. That is, the tape hole 312h, together with the casing hole 200h and the base hole 320h, may be configured to define the route through which the gas and the like in the casing part 200 are discharged to the outside. In contrast, the above-mentioned protective layer 314 is configured to cover the tape hole 312h.

For example, as illustrated in the drawings, the adhesive layer 312 and the tape hole 312h may each have a rectangular shape. Further, a width of the adhesive layer 312, which is a distance between an outer periphery of the adhesive layer 312 and the tape hole 312h, may be constant.

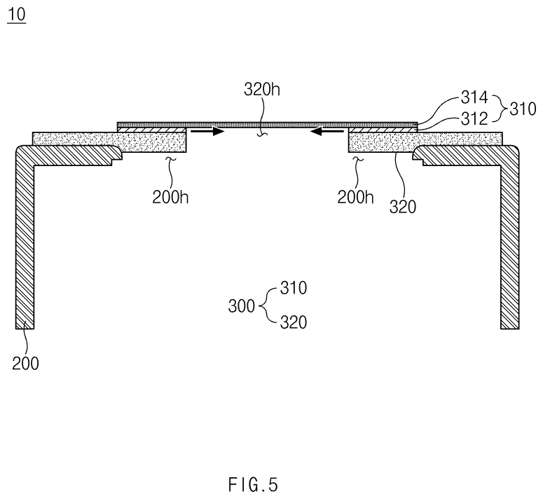

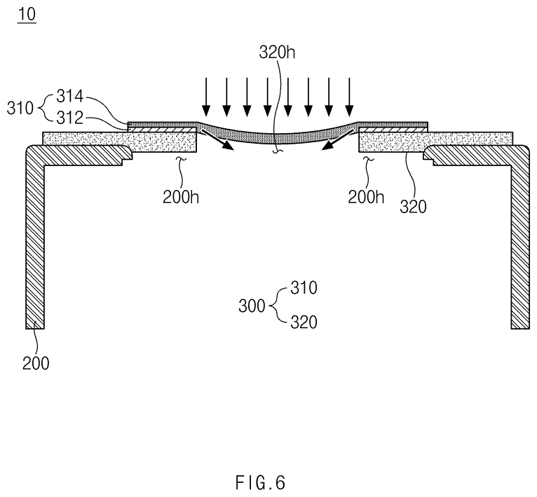

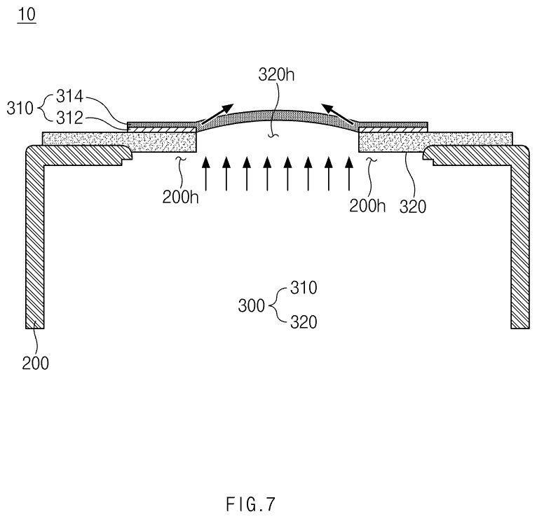

FIG. 5 is a view illustrating a state of the fracturable part provided in the battery assembly in case that internal pressure and external pressure are similar to each other, and FIG. 6 is a view illustrating a state of the fracturable part provided in the battery assembly in case that external pressure is higher than internal pressure. FIG. 7 is a view illustrating a state of the fracturable part provided in the battery assembly in case that internal pressure is higher than external pressure.

Meanwhile, according to the present disclosure, the tape member 310 may be configured to satisfy predetermined expressions.

More specifically, as illustrated in the drawings, the tape hole 312h may have a rectangular shape in which a length of a first side is a and a length of a second side is b, and the adhesive layer 312 may have a rectangular shape in which a length of a first side facing the first side of the tape hole 312h is c and a length of a second side facing the second side of the tape hole 312h is d. In this case, under a condition in which the external pressure of the casing part 200 is equal to or higher than the internal pressure of the casing part 200, the tape member 310 may be configured to satisfy Expressions 1 and 2 below.
Expression 1: F_{ad}×a>Pa²b/{2(a+b)}
Expression 2: F_{ad}×b>Pab²/{2(a+b)}

(Here, P represents a difference between external pressure and internal pressure of the casing part, and F_{ad} represents a bonding force per unit length of the tape member.)

The left-hand sides in Expressions 1 and 2 may indicate adhesive forces of the portions corresponding to the first and second sides of the adhesive layer 312, and the right-hand sides in Expressions 1 and 2 may indicate external forces applied to the region of the protective layer 314, which faces the tape hole 312h, by a difference between the external pressure and the internal pressure of the casing part 200.

In addition, according to the present disclosure, under the condition in which the external pressure of the casing part 200 is equal to or higher than the internal pressure of the casing part 200, the tape member 310 may be configured to satisfy Expressions 3 and 4 below.
Expression 3: [Pa²b/{2(a+b)}]/σₜ<{d-b)/2}×(1+ε)
Expression 4: [Pab²/{2(a+b)}}/σₜ<{c-a)/2}×(1+ε)

(Here, σₜ represents tensile strength (unit: N/mm) of the tape member, and ε represents extensibility of the tape member.)

Expressions 1, 2, 3, and 4 may be conditions in which the protective layer 314 of the tape member 310 is not spaced apart from the adhesive layer 312 when the battery assembly 10 is in a normal state, i.e., when the battery cell 100 is not in a thermal runaway state. More specifically, Expressions 1 and 2 may correspond to a condition, i.e., FIG. 5 in which the difference between the external pressure and the internal pressure of the casing part 200 is relatively small, and Expressions 3 and 4 may correspond to a condition, i.e., FIG. 6 in which the external pressure of the casing part 200 is higher than the internal pressure of the casing part 200 and the difference between the external pressure and the internal pressure is relatively large.

Meanwhile, according to the present disclosure, under a condition in which thermal runaway occurs in at least some of the plurality of battery cells 100, the tape member 310 may be configured to satisfy Expressions 5 and 6 below.
Expression 5: Pa²b/{2(a+b)}×y>F_{ad}×a
Expression 6: Pab²/{2(a+b)}×y>F_{ad}×b

(Here, P represents a difference between external pressure and internal pressure of the casing part, F_{ad} represents a bonding force per unit length of the tape member, and y represents a decrease rate of a bonding force of the adhesive layer in accordance with an increase in temperature.)

Expressions 5 and 6 may be expressions that take into account the decrease rate of the bonding force of the adhesive layer 312 when thermal runaway occurs in the battery cell 100, a temperature in the casing part 200 increases, and a temperature of the tape member 310 also increases. More specifically, Expressions 5 and 6 may correspond to a condition, i.e., FIG. 7 in which the protective layer 314 is spaced apart from the adhesive layer 312 in response to the thermal runaway in the battery cell 100, such that the gas and the like in the battery assembly are discharged to the outside through the casing hole 200h, the tape hole 312h, and the base hole 320h. That is, in the event of thermal runaway in the battery cell, the temperature and pressure in the casing part 200 are increased together, such that the pressure applied to the tape member may increase, and the bonding force of the adhesive layer may decrease.

Meanwhile, the battery assembly 10 according to the present disclosure may be mounted in aerial mobility vehicles such as drones that fly through the air. For example, the battery assembly 10 according to the present disclosure may be mounted in bodies, wings, or the like of the aerial mobility vehicles.

In case that the battery module or the battery pack is mounted in the aerial mobility vehicle, the battery module or the battery pack is often exposed to downwash applied to the aerial mobility vehicle because of the nature of the aerial mobility vehicle. In this case, the battery module or the battery pack is exposed to pressure and vibration caused by the downwash. In this case, a problem may occur in which a venting device provided in the battery module or the battery pack operates erroneously. In contrast, each country has or is making regulations that require batteries mounted in aerial mobility vehicles to discharge a larger amount of gas in a shorter period of time than ground mobility vehicles.

According to the present disclosure, the venting device for discharging the gas and the like includes the tape member 310 and is configured to satisfy the above-mentioned expressions, which provides an advantage in that the venting device does not operate erroneously at ordinary times, and the venting device may operate quickly in the event of an emergency.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery assembly comprising:
a plurality of battery cells each comprising electrodes and separators;
a casing part defining an internal space configured to accommodate the plurality of battery cells; and
a fracturable part attached to one side of the casing part,
wherein the casing part comprises a casing hole formed at one side thereof, and
wherein the fracturable part comprises a tape member disposed to cover at least a portion of the casing hole and bonded to the casing part or to another structural component of the fracturable part.

2. The battery assembly of claim 1,
wherein the tape member comprises a material having an adhesive property that decreases in at least a specific temperature range as the temperature increases.

3. The battery assembly of claim 1,
wherein the fracturable part further comprises a base member fixedly coupled to a region of the casing part that defines a boundary of the casing hole, the base member having a base hole configured to be in communication with at least a portion of the casing hole, and
wherein the tape member is configured to cover the base hole and is bonded to a region of the base member that defines a boundary of the base hole.

4. The battery assembly of claim 3,
wherein a thickness of the base member is smaller than a thickness of the region of the casing part to which the base member is fixedly coupled.

5. The battery assembly of claim 3,
wherein the fracturable part further comprises a penetration member configured to penetrate both the base member and the casing part, and
wherein the penetration member comprises a plurality of penetration members spaced apart from one another along a peripheral region of the casing hole.

6. The battery assembly of claim 3, wherein the tape member comprises:
an adhesive layer attached to the base member; and
a protective layer disposed on an outer surface of the adhesive layer.

7. The battery assembly of claim 6,
wherein the adhesive layer comprises an acrylic-based adhesive agent or a silicon-based adhesive agent, and
wherein the protective layer comprises aluminum.

8. The battery assembly of claim 6,
wherein a tape hole is formed in the adhesive layer and configured to communicate with the casing hole and the base hole, and
wherein the protective layer is configured to cover the tape hole.

9. The battery assembly of claim 8,
wherein each of the adhesive layer and the tape hole has a rectangular shape.

10. The battery assembly of claim 9,
wherein a width of the adhesive layer, defined as a distance between an outer periphery of the adhesive layer and the tape hole, is constant.

11. The battery assembly of claim 8,
wherein the tape hole has a rectangular shape having a first side of length a and a second side of length b,
wherein the tape member is configured to satisfy the following Expressions 1 and 2 under a condition in which an external pressure applied to the casing part is equal to or greater than an internal pressure of the casing part:
Expression 1: F_{ad}×a>Pa²b/{2(a+b)},
Expression 2: F_{ad}×b>Pab²/{2(a+b)}, and
wherein P represents a difference between the external pressure and the internal pressure of the casing part, and F_{ad} represents a bonding force per unit length of the tape member.

12. The battery assembly of claim 8,
wherein the tape hole has a rectangular shape having a first side of length a and a second side of length b,
wherein the adhesive layer has a rectangular shape having a first side of length c facing the first side of the tape hole and a second side of length d facing the second side of the tape hole,
wherein the tape member is configured to satisfy the following Expressions 3 and 4 under a condition in which an external pressure applied to the casing part is equal to or greater than an internal pressure of the casing part:
Expression 3: [Pa²b/{2(a+b)}]/σₜ<{(d-b)/2}×(1+ε) ,
Expression 4: [Pab²/{2(a+b)}}/σₜ<{(c-a)/2}×(1+ε), and
wherein σₜ represents a tensile strength (N/mm) of the tape member, and ε represents extensibility of the tape member.

13. The battery assembly of claim 8,
wherein the tape hole has a rectangular shape having a first side of length a and a second side of length b,
wherein the tape member is configured to satisfy the following Expressions 5 and 6 under a condition in which thermal runaway occurs in at least some of the plurality of battery cells,
Expression 5: Pa²b/{2(a+b)}×y>F_{ad}×a,
Expression 6: Pab²/{2(a+b)}×y>F_{ad}×b, and
wherein P represents a pressure difference between an external pressure and an internal pressure of the casing part, F_{ad} represents a bonding force per unit length of the tape member, and y represents a decrease rate of a bonding force of the adhesive layer in response to an increase in temperature.

14. A battery assembly comprising:
a plurality of battery cells each comprising electrodes and separators;
a casing part defining an internal space configured to accommodate the plurality of battery cells, and having a casing hole formed at one side thereof;
a base member coupled to a region of the casing part that defines a boundary of the casing hole and having a base hole formed to communicate with at least a partial region of the casing hole; and
a tape member configured to cover the base hole and bonded to the base member,
wherein the tape member comprises a temperature-responsive adhesive layer and a protective layer, and
wherein the tape member is configured to peel off from the casing part when an internal pressure of the casing part exceeds a predetermined threshold, thereby releasing internal gas or pressure.

15. The battery assembly of claim 14,
wherein the adhesive layer is configured such that its bonding strength decreases with increasing temperature, and
wherein the adhesive layer comprises at least one of an acrylic-based adhesive or a silicone-based adhesive.

16. The battery assembly of claim 14,
wherein the protective layer comprises a metal material including aluminum, and
wherein the tape member is configured to maintain structural integrity of the protective layer at room temperature and to fracture at elevated temperatures.

17. The battery assembly of claim 14,
wherein the tape member has a rectangular hole formed therethrough, and
wherein the tape member is configured to satisfy a pressure-bonding balance relationship such that a pressure difference across the casing hole results in detachment of the tape member based on bonding force per unit length.
